(19) United States
(12) Patent Application Publication
(10) Pub. No.: US 2008/0005224 A1
(43) Pub. Date: Jan. 3, 2008

(54) System for vending electronic guide devices

(76) Inventors: William H. Ferguson, Jackson, WY (US); Katharine G. Lee, Jackson, WY (US)

Correspondence Address: BOYLE FREDRICKSON S.C., 840 North Plankinton Avenue, MILWAUKEE, WI, 53203, US

(21) Appl. No.: 11/436,003

(22) Filed: May 17, 2006

(51) Int. Cl. G06F 15/16

(52) U.S. Cl. 709/203

(57) ABSTRACT

A system of enclosures or units each including a plurality of electronic guide devices in which the guide devices are stored, indexed, maintained, and selectively vended from a microprocessor controlled vending machine. The customer uses the guide device while traversing an area of interest to provide facts, history, stories, destination information, entertainment, and other relevant information. The units communicate with one another to maximize the efficiency of delivering fully operational guide devices.

### CROSS-REFERENCE TO RELATED APPLICATIONS

This application is related to U.S. patent application Ser. No. ______ entitled “Vending of an Electronic Guide Device” filed on even date herewith in the name of the same inventors, and which is expressly incorporated by reference herein.

### BACKGROUND OF THE INVENTION

1. Field of the Invention

The invention relates to the field of vending machines and the automatic vending of guide services, and in particular to systems of multiple vending units for the vending of electronic guide services and automatic rental of electronic guide devices.

2. Description of Related Art

Vending machines and the automated vending of consumer goods is well known worldwide. The variety of goods has increased and the provision of services, including interactive banking, informational access, form completion and printing, music recording, DVD rental, internet access and other services has also become common in the realm of automated vending.

Electronic guide devices are a more recent entry into the world market, but have begun to reach customers in places as varied as museums, outdoor parks, particular neighborhoods of cities, and college campuses. Indeed, the advent of GPS (the US military's Global Positioning System satellites and technology) has allowed electronics manufacturers to build handheld devices that can provide detailed navigational instructions, including driving directions in vehicles. GPS is very well known and used in many different applications. For example, automakers in the US and other countries have begun including such GPS devices in their vehicles, and car rental companies have begun providing the units in their rental cars. GPS has been used more recently in guide devices that provide information other than simple navigation and information on local services, such as gas stations, hotels, the location of parks, national monuments, and any number of roadside attractions. GPS device manufacturers now build and sell GPS navigation devices that include guidance for driving, boating, and even for hiking and other non-motor vehicle travel.

The most recent entry into the guidance field are companies that rent, loan or sell devices that provide historical, scientific, celebrity, point of view or other types of information to their customers. These companies include Hoppy System, Technopole de l'Aube-BP 601-10901 Troyes Cedex 9, www.hoppy.info; IntelliTours LLC, 7038 General Haig St., New Orleans, La. 70124, intellitours.com; PanetAudioGuide S.r.l., Sestrier Cannaregio 5393, Venezia 30100, www.planetaudioguide.com; GoCar Rentals, 2715 Hyde Street, San Francisco, Calif. 94109, www.gocarsf.com; and Spotlight Mobile, Inc., 17 SE 3rd Avenue, Suite 501, Portland, Oreg. 97214 www.spotlightmobile.com. These most recent entries into the market share the intent to not only direct their customers to particular locations and sights, but may also to educate the customers using auditory and visual content provided by the electronic guide devices. Not all of these devices are triggered using location data from GPS. Some use other systems that can provide sufficiently accurate location data, such as radio frequency broadcasts, WiFi, Bluetooth, infrared, GLONASS satellite, and many other types of broadcast technology.

Unfortunately, rental of such devices has not become widespread due to the prohibitive cost of high-volume rental. As anyone who has visited a busy national park office or visitors' center will know, there are inherent limitations based on the size of the building and staff for the number of tourists that can be served by the rangers or other personnel in these locations. Waiting in long lines to buy a map, get advice or information, or to buy a guide book is anathema to the tourists' use of their limited time in any one location.

Vending machines in general are known to have advantages over human based dispensing systems. The footprint of the machine is small, the rate of service is high, and the provision of multiple units is by nature quite simple. Further, such machines can be accessed directly from a vehicle, as the advent of ATMs (Automatic Teller Machines) has demonstrated. The efficiency of vending machines is well known, and is evidenced by their prevalence world-wide.

The known art of vending machines has expanded into the rental of reusable goods, such as DVDs containing movies and other information, the best new example being the Redbox (www.redbox.com) vending machines placed in many McDonald's fast-food restaurants to provide DVDs with movies for convenient rental. Providing these services requires the use of software and hardware that support the use of credit cards, connection to a network or the internet, printer, mechanical goods handlers inside the machine, and other well-known components. Unique to vending machines performing rental transactions, however, is the need for mechanical, electronic and software provisions for handling returned goods, and in some cases preparation of those goods for re-vending.

The vending of electronic devices is known, but still not common. The early patent by Bishop, McClure, Dana and Storch, U.S. Pat. No 4,951,308: Automated vending of cellular hand-held guides and cellular guide services (“the '308 patent”) demonstrates that vending of electronics has been known, but the absence of such services shows that the technology has not come into its own as a useful market. The '308 patent is hereby incorporated herein to the extent relevant, and as discussed below.

Due to the complexity of rental transactions, the training required for the operation, maintenance, and troubleshooting of electronic devices, and because of the round-the-clock nature of access to national parks and other areas of interest, the rental of valuable electronics has been too impractical to support market entry by high-volume suppliers. Thus, electronic guide devices have not been provided in a sufficiently convenient and accessible manner, with the proper information available through them, to supply the potential markets in the national parks, state parks, national monuments, cities, neighborhoods, and historically or culturally significant locations of every type, i.e., in any place that a tourist might hope to experience something unique.

The above-listed examples of such companies, Hoppy System, IntelliTours LLC, PlanetAudioGuide S.r.l., GoCar Rentals, and Spotlight Mobile, Inc., all operate in the mode of renting fewer than one hundred devices on any given day, at any particular location due to the time, counter space and personnel required to rent in higher volumes. A car rental agency at a major airport, for example, rents in high volume, and requires many people, substantial amounts of time, and many feet of counter space. To serve a national park or other area that receives thousands of visitors per day, a much higher volume method of rental is required. Thus, what is necessary is a method and the supporting apparatus that will overcome the limitations of the prior art and allow high-volume rental of guide devices with entertaining and information-rich content.

### SUMMARY OF THE INVENTION

In accordance with one aspect of the invention, a plurality of electronic guide devices are stored, indexed, maintained, and selectively vended from an enclosure of a device such that preferably takes the form of a microprocessor controlled vending machine or other secure enclosure/structure such as one built into an existing building, similar to an ATM Customers may provide their credit or other payment information, select the time period of use, content, language and format of the guide service, and agree to the terms of use. The vending machine then checks and debits the credit of the customer, selects which electronic guide device to provide, programs the user preferences into the device, and vends it and any collateral materials to the customer. The customer uses the guide device while traveling through an area of interest to provide information that may include, for example, historical facts, stories, destination information, or entertainment information. After use, the customer returns the device to the same or a similar vending machine which checks the usage against the billed-for period of use and the functionality of the device, bills the customer's credit again, if necessary, and provides the customer with a receipt. During storage of the device, the vending machine records any useful data, such as distance, time and path of travel, places stopped, things avoided, speeds in specific areas, average speeds, and any other information useful for marketing or park management, from the device, recharges the device's internal battery, and prepares it for re-vending.

More particularly, the preferred embodiments are directed to a system for vending rental electronic guide devices for places of interest to tourists or other information/experience/entertainment seekers. These embodiments may combine several:
(1) microprocessor driven electromechanical storage and dispensing mechanism that retains and selectively dispenses electronic guide devices, to be referred to (without limitation to the known art of the same name) as a “vending machine”,
(2) electronic guide devices designed for providing information, experience and/or entertainment relevant to a specified area or areas,
(3) the method of renting the devices on a time or per use basis from the vending machine and the return of the devices to the vending machine or any of the other vending machines in the area, and
(4) communication among the vending units.

In order to dispense the guide devices, the known art of software requiring payment from the customer, hardware for reading credit/debit card or other banking-linked technology for payment, and a link, wireless or otherwise, to a network sufficient to allow authorization and payment are desired.

In order to recharge, reinitialize, perform any required diagnostics, and record the return of the guide devices, an electronic or wireless link between the guide devices and the vending machine they are stored in is desired. Only if the devices are battery powered will they require recharging, but it is also possible that an exterior power source may be provided, such as a connection to the cigarette lighter-type 12-volt source that is common in manufactured vehicles. The devices may not require initialization or diagnostic analysis, but in order to ascertain the time period of rental, whether to check that period against the period for which the device was originally rented or to simply measure the time and charge the customer's credit account accordingly, some recording of the deposit of the device into the vending machine may be required. If the customer fails to return the device to the vending machine, the customer may be charged for the cost of replacing the device or some other relevant cost to be determined by business need. The customer, in fear of this cost, might also return the device to the company vending it in person, by mail, or by carrier. While less convenient for the vending company, this possibility is part of the preferred embodiments because the return vending machine may not be located conveniently, may be full, or might not be operational. In this case the customer will have received some instructions regarding how to perform the return and will be billed according to the vending company's policy.

If operating properly, electronic guide devices are vended automatically, and the customer is billed accordingly.

Another aspect of the invention resides in a method for automatically providing guide services from a plurality of vending units including at least some of the steps of:
(1) Storing a number of electronic guide devices;
(2) Configuring the plurality of electronic guide devices so that at least some of them are prepared and available for rental and use;
(3) Selecting one of the stored devices that is ready for rental upon customer demand;
(4) Dispensing the device in response to approval of the customer's credit or receipt of sufficient payment such as debit card or cash;
(5) Returning the device by the customer or a third party, allowing for re-vending of the device by the vending machine; and
(6) Communicating between the vending units with or without employing a central server.

The information provided by the guide device may come from a single narrator voice, as is common in audio tours, but it might also come in the form of radio theatre, i.e., the interplay among a group of characters or voices giving the same information in a vastly more entertaining way. This is the current best mode of the invention. As anyone who has taken an audio tour with a single narrator has probably experienced, a method of making the program lively and interesting will greatly increase the amount of information retained and improve the experience altogether. Using characters that well represent different facets of the area being explored lends itself to teaching the listener about the flora, fauna, geology, geography, history, architecture, politics, and anecdotes local to the area. This type of entertaining audio tour is largely unknown, and certainly not a part of current GPS triggered audio tours.

Preferably, an enclosure or other structure that accommodates a plurality of guide devices, including a permanent installation with distribution of components according to architectural preference, rack mount system, mobile kiosk, conventional vending machine, or other single or multiple unit installations, including an ATM-type apparatus built into an existing structure, a dispensing mechanism for dispensing the guide devices from the unit or enclosure and a CPU responsive to user input, to control the dispensing mechanism to dispense at least one of the guide devices from the enclosure.

According to a first aspect of the preferred embodiment, a system of distributing electronic guide devices includes at least two structures that accommodate and transact corresponding electronic guide devices, each structure including a CPU and a communication device.

According to another aspect of this preferred embodiment, the system further includes a server that communicates with the CPU of each structure via the corresponding communication device. The CPU communicates with at least one of the guide devices and relays information regarding the guide device to the server.

In another aspect of this preferred embodiment, the units are adapted to test at least one of the guide devices for operability and communicates a status condition of the guide device to the server.

According to a further aspect of this preferred embodiment, the units or structures for accommodating and transacting electronic guide devices include an enclosure that accommodates a plurality of the guide devices, and a dispensing mechanism for dispensing the guide devices from the enclosure. The CPU is responsive to user input to control the dispensing mechanism to dispense at least one of the guide devices from the enclosure.

According to another aspect of this preferred embodiment, a sensor that communicates with at least one of the guide devices to determine if the guide device is vendable is provided. For example, the guide device may be battery powered and the sensor may detect whether the guide device has a threshold charge.

In a still further aspect of this preferred embodiment, the structure is one of a vending machine, an apparatus built into an existing structure and a kiosk.

In yet another aspect of this preferred embodiment, a plurality of structures that each accommodate a plurality of guide devices is provided. A server may be employed to communicate with the structures to regulate the distribution of the guide devices.

According to another aspect of this preferred embodiment, the method includes storing a plurality of electronic guide devices in at least two structures each having a user interface. The method also includes communicating with a customer, via the user interface, so as to select at least one guide device, and then dispensing the guide device based on the communicating step.

In a further aspect of this preferred embodiment, the method includes receiving and processing the guide device once the guide device is returned by the customer. In this case, preferably, the receiving and processing step includes providing a dispensing/receiving mechanism.

According to further aspect of this preferred embodiment, the method includes providing at least two structures that accommodate and transact corresponding electronic guide devices, each structure including a CPU and a communication device. The method also includes communicating guide device information between the two structures.

According to yet another aspect of this preferred embodiment, the communicating step includes using a server that communicates with the CPUs via the corresponding communication devices.

These and other objects, features, and advantages of the invention will become apparent to those skilled in the art from the following detailed description and the accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

A preferred exemplary embodiment of the invention is illustrated in the accompanying drawings in which like reference numerals represent like parts throughout, and in which:

FIG. 1 is a simplified block diagram of an electronic guide device usable in a preferred embodiment of the invention;

FIG. 2 is a simplified block diagram of a vending machine usable in a preferred embodiment of the invention;

FIG. 3 is a flow chart of a method wherein an electronic guide device is prepared for vending, demanded by a customer, vended to the customer, setup by the customer, used by the customer, and returned by the customer;

FIG. 4 is a generalized flow chart of a portion of the method of the flow chart of FIG. 4 wherein an electronic guide device is prepared for vending;

FIG. 5 is a flow chart of a portion of the method of the flow chart of FIG. 4 wherein an electronic guide device is demanded by a customer and vended to that customer;

FIG. 6 is a flow chart of a portion of the method of the flow chart of FIG. 4 wherein an electronic guide device is set up for use by a customer;

FIG. 7 is a flow chart of a portion of the method of the flow chart of FIG. 4 wherein an electronic guide device is used by a customer; and

FIG. 8 is a flow chart of a portion of the method of the flow chart of FIG. 4 wherein an electronic guide device is returned by a customer.

### DETAILED DESCRIPTION OF THE PREFERRED EMBODIMENT

Guide services are provided by an electronic guide device automatically vended from a vending machine or self-service kiosk and the guide device is used and then returned to the same or a similar vending machine and the customer's credit billed for the service. In this case, a system of vending machines is provided, the vending machines having the ability to communicate with one another.

In the preferred embodiment, the electronic guide device includes a GPS receiver and/or other locating device, a battery, computer-type memory containing recorded data for presentation, a microprocessor suitable to play back such recorded data, an FM or similar transmitter to broadcast auditory information, and/or a speaker.

The guide device 1-1 in the preferred embodiment is scaled to fit on almost any vehicle dashboard, and is roughly 4 inches deep by six inches wide by four inches tall, but is preferably rounded to blend into the vehicle environment. The case is constructed of a durable, soft rubber-type material that protects the device against shock if dropped, liquids if spilled upon, and that grips the vehicle dashboard to prevent slips and slides in turns and during acceleration and deceleration. The case may have a plurality of buttons that are easy to identify as to their function by their color and labeling, and are sized to allow easy use even during a bumpy ride. In the preferred embodiment, there are two buttons allowing for “skip” and “back” functions. The guide device may be colored to suit the then current rental marketing methodology, specific vehicle interiors, or individual preference. The case has a waterproof opening allowing the onboard speaker to be heard, but not diminish the protective or aesthetic functions of the case. As discussed below, the device may be shaped to fit and indexing function so that it may be inserted into the receiving portion of the vending machine in only one way, much as a SIM card is inserted into a modern cellular phone.

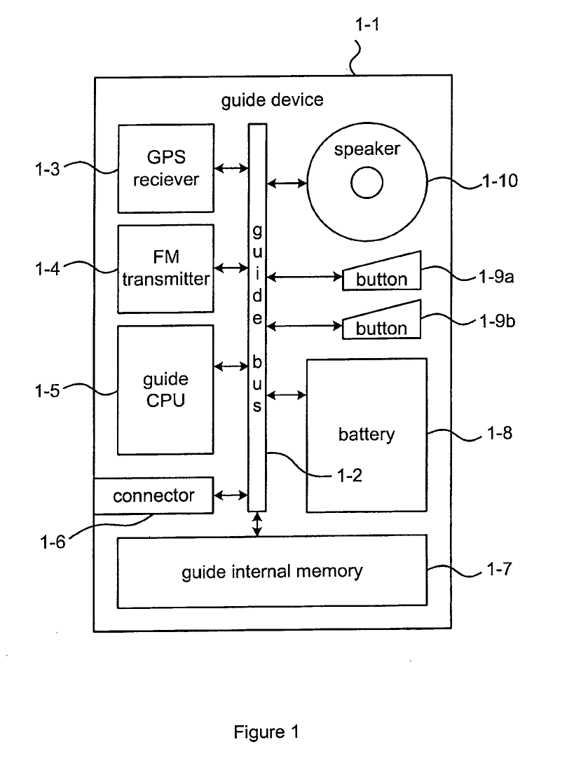

FIG. 1 depicts a simplified block diagram of the electronic and hardware components contained within a guide device 1-1 usable in the preferred embodiment and connected to one another by a guide bus 1-2. All of these components, and the effort required to program them (if required) and connect them to the guide bus 1-2, are well known to those skilled in the art. These components include a GPS receiver 1-3. An FM transmitter 1-4 broadcasts a low-power radio-frequency signal intended to be received by the customer's vehicle's radio, allowing the customer to listen to the output through their vehicle's radio or a self contained radio such as a Walkman® in the case of a walking tour. Such a transmitter 1-4 might broadcast on any available frequency (subject to FCC rules in the US) to be received by a customer's personal radio. It could alternatively be received on some other device such as Wi-Fi or Bluetooth, and could also broadcast in the infra-red or other frequencies in the electromagnetic spectrum to suitable receivers. The guide CPU 1-5 may operate on a commercially available reduced size operating system, e.g., Microsoft Windows CE. In addition, the GPS receiver could be replaced by or supplemented with another locating device that determines the relative or actual position of the guide device 1-1. For instance, a receiver in the guide device 1-1 could receive short-range signals from short range transmitters located at points of interest along a guided route.

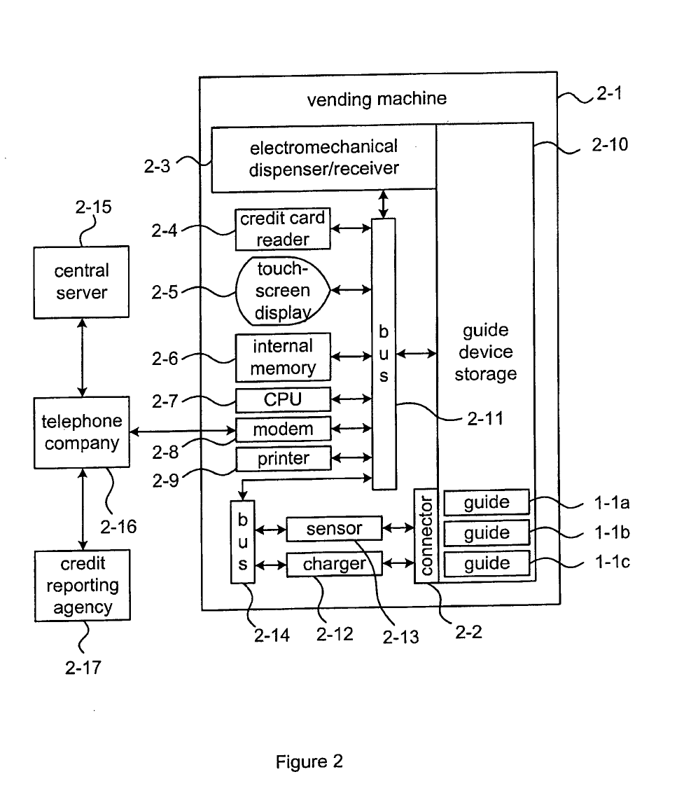

A connector 1-6 in the guide device 1-1 cooperates with a connector 2-2 on the vending machine (see FIG. 2) to provide an electrical connection between guide device 1-1, and the components of a vending machine 2-1 that must interact with guide device 1-1, such as battery charging, device reset, data acquisition, internal information updating, and diagnostics, among others. A guide internal memory 1-7 contains all necessary data to allow the guide device 1-1 to operate and to provide audio, and potentially other information, to customers. Battery 1-8 provides power to operate guide device 1-1, though there could also be any number of other power sources such as a 12 volt connector to a vehicle's standard cigarette lighter jack, or a solar panel built into the case or otherwise coupled to the guide device 1-1. In the preferred embodiment, guide devices 1-1a-1-1c each include a Lithium-ion battery 1-8 of such capacity as to allow use of the guide device for several days of intermittent or continuous use. Manual interfaces such as buttons 1-9a and 1-9b represent one mode of an available plurality of user input devices, including but not limited to all types of buttons, thumb wheels, touch pads, touchscreens, pointing devices, voice command receivers, remote controls and the like, and provide an interface allowing the customer to interact with the guide device 1-1 to respond to questions, make choices, adjust settings, adjust the volume, adjust the FM transmitter 1-4 output frequency, or any other setting that may be relevant to a customer. Finally, speaker 1-10 provides a well-known and very reliable mechanism for broadcasting the content to the customer, in the case of a customer that does not want to or cannot make use of FM transmitter 1-4.

There is no video screen, headphone jack, or other type of output device shown in FIG. 1, however it is understood that there are many types of information and entertainment, auditory, visual, and otherwise that this device could provide depending on customer and market preferences. Provision of all such information and entertainment is intended to be within the scope of the invention, and video screens and other output devices are well known in the art and are contemplated as part of the invention herein.

FIG. 2 depicts a simplified block diagram of the electronics and hardware contained within the structure or enclosure of the vending machine or kiosk 2-1. The vending machine or unit 2-1 is preferably an enclosure and is comprised of a service-accessible cabinet that allows for access to, service of and changeout of the inventory of electronic guide devices 1-1. Though the term enclosure is used herein its use does not imply that the vending machine or kiosks are necessarily fully enclosed. Preferably, a number of electronic guide devices can be stored in three dimensional array similar to DVD storage in the Redbox vending machine (manufactured by DVDPlay), and the cellular phone vending machine discussed in the '308 patent, and discussed above. Alternatively, an ATM-type apparatus could be employed. By doing so, a number of customers similar to that served by, for example, a car rental location at an airport can be served. In this case, however, the customers may be served using no personnel, no counter, and moreover, the same or less amount of time. Of course, several such apparatus can serve a large volume of people in a short amount of time. The details of the electromechanical mechanism and how it is driven to deliver a selected guide device 1-1 is not further described other than to provide a background to fully illustrate the preferred embodiment. The devices are stored in a randomly accessible three dimensional array as seen in FIG. 2, with electronics and mechanical assembly necessary and sufficient for charging, diagnostics, resetting and dispensing of any guide device 1-1 at any time.

A touchscreen display 2-5 is mounted for customer viewing and provides the interface with the customer. The customer is able to input information into the vending machine 2-1 through keys on the touchscreen display 2-5 or another user input device, most likely a keypad (not shown) in response to prompts on the display 2-5 and through a conventional credit card reader 2-4. Written operating instructions may be provided in a permanent or semi-permanent graphic display (not shown) attached to the exterior of the vending machine 2-1. The selected guide device 1-1 is delivered to the customer through a door assembly (not shown) that is at the front of an electromechanical dispenser/receiver 2-3 and, preferably, returned through the same door assembly. Such dispenser/receiver 2-3 may any suitable known vending or storage method, but reasonable modes include employing a pick-and-place mechanical arm with slots for the storage and electrical interface of the guide devices in an array that allows random access, or may a belt and tray configuration, or a rotating tower with cubbies in the mode of fresh food dispensing vending machines. Moreover, though electromechanical apparatus 2-3 is preferably a dispenser/receiver, the apparatus may not, for example, “receive,” while dispensing and receiving may occur at different units and locations.

Touchscreen display 2-5 and credit card reader 2-4 are each conventional and have previously been incorporated in vending machines. These devices were discussed in the '308 patent, and their usual variants are included within the scope of this invention sufficient to complete the rental transaction. A variety of other devices found in vending machines may alternatively be used to dispense, and possibly also receive, guide devices from and to the enclosure of the vending machine. It should be noted that “dispensing from the enclosure” does not mean that the guide devices must be physically ejected from the enclosure. To the contrary, they will typically remain in the enclosure but will be moved from a storage area where they are inaccessible to the user to another area, such as shelf or a slot, where they are accessible by the user for removal from the enclosure.

The instant embodiment contemplates payment by the customer for rental and any security deposit or authorization using the customer's credit card. However, it is entirely within the scope of the present invention that the great variety of other types or methods of financial transactions may also be accommodated. The use of bill and coin handlers, cellular phone “wallet” type transactions, or similar transactions using any unique identifiers, including biometric, for access to the customer's financial or credit accounts. These and the many financial methods discussed in the '308 patent adequately indicate the types of methods intended to be within the scope of the present invention, but any method of payment may suffice.

The preferred embodiment of the vending machine 2-1 includes guide device storage (2-10) retaining a plurality of guide devices 1-1a-1-1-c prior to rental or after return, and electromechanical dispenser/receiver 2-3 for dispensing to or receiving from customers the guide devices 1-1a-1-1c as controlled by CPU 2-7 through bus 2-10. “CPU” or central processing unit is used herein to refer to a processor, for example, contained on a simple chip, but includes any other computer or system of onboard and/or offboard controllers capable of working alone or together to perform the functions recited herein. Credit card reader 2-4, and touchscreen display 2-5 allow a customer to interact with the vending machine 2-1 including providing credit or other payment information by swiping their card or otherwise interfacing with the machine 2-1, selecting from available rental choices, and payment. Also provided are an internal memory device 2-6 for storing and providing access to digital data, a CPU 2-7 that may consist of a conventional microprocessor, and busses 2-11 and 2-14 as discussed in the '308 patent operate together to link, drive and record the functions and transactions of the user interface and guide handling systems. Linked to the CPU 2-7 through bus 2-11 is a modem 2-8 that allows the CPU 2-7 to communicate with a central server 2-15 and any relevant credit reporting agency 2-17 via a telephone company 2-16 through wired or wireless communication, including satellite, cellular, telephone line, and other commonly known methods of transmission.

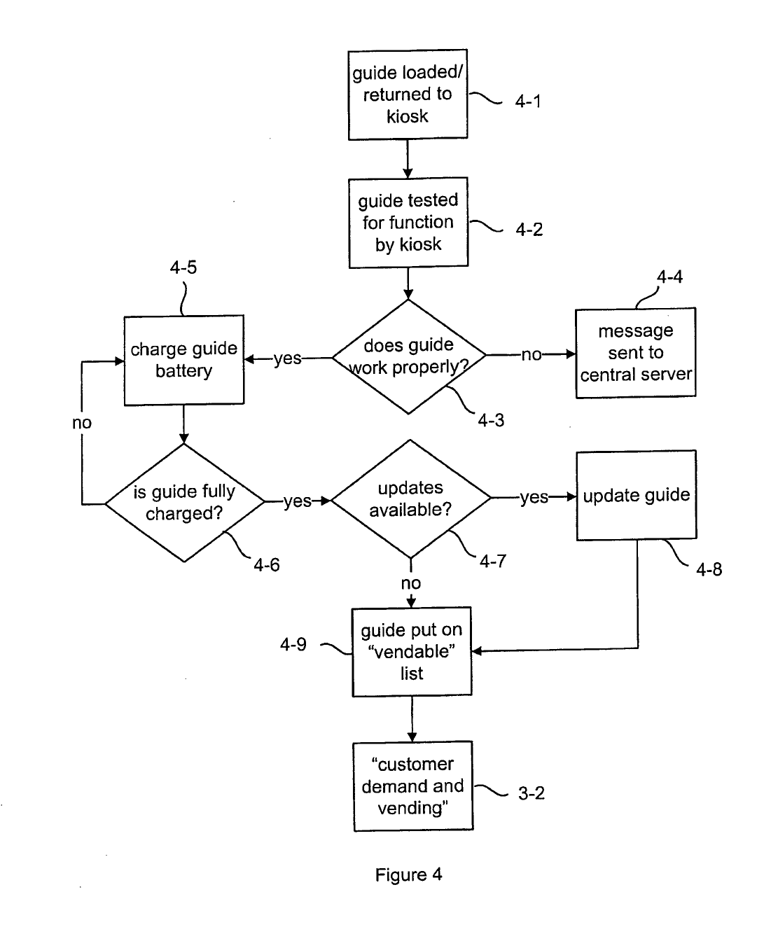

Sensor 2-13 and charger 2-12 are electrically connected to the guide devices 1-1a-1-1c, through connector 2-2 and connected to CPU 2-7 through busses 2-14 and 2-11, allowing the sensor to interact with each guide device 1-1a-1-1c individually to determine functionality and level of charge, as well as providing memory updates, and a reset signal if necessary. Charger 2-12 may either provide a quick charge to the battery 1-8 in each guide device 1-1a-1-1c or to provide a trickle charge to each battery 1-8, or both. In either case, as discussed in the '308 patent, the sensor 2-13 functions to ensure that each battery is fully recharged before the associated guide device is allowed to be re-dispensed, and can display the actual charge condition of each of the onboard batteries 1-8 to allow a determination to be made within CPU 2-7 when each unit can be returned to the active inventory, thereby allowing maximized inventory turnover. Thus, charger 2-12 can then provide charge to each guide device 1-1a-1-1c individually as required per FIG. 4. Also as generally discussed in the '308 patent, the hardware, electronics and software cooperate to properly dispense a guide device 1-1 selected by the software to the door assembly from a known inventory position, or placing a customer-returned guide device 1-1 received through a door assembly (not shown) into electromechanical dispenser/receiver 2-3 into an available inventory position. Once the guide device 1-1 is returned, printer 2-9 will provide a final receipt.

As noted generally above, for purposes of communication with credit, financial, identification and other vending authorization services, as well as for contact with a central server for transmitting and receiving vending data, trouble reports, customer data, information updates for the guide devices, and other useful communications, a modem 2-8 is provided and may be connected by conventional landlines, cellular, satellite or other means of wireless communication to each of the servers for these types of information, or simply to the internet for similar access.

The preferred embodiment further includes several different components not typically found within prior art dispensers, including a receiving assembly for each guide device with a plurality of contacts disposed on the exterior of each guide device (connector 1-6) with a matching connector 2-2 disposed in each receiving fixture to allow selective communication between the guide devices 1-1a-1-1c and the CPU 2-7 through communication with the sensor 2-13 and charger 2-12. To the extent desired, indexing features (not shown) may be disposed on the exterior of the guides 1-1 and the interior of the receiving fixtures (not shown) to prevent misalignment between the guide devices 1-1 and their respective receiving fixtures. Alternatively, or together therewith, the guide devices themselves may have an exterior shape that mates with the interior shape of their receiving fixtures that prevents misalignment.

The plurality of contacts between the connector 1-6 on guide device 1-1 and the connector 2-2 in the receiving assembly in which the guide device is placed in may also include contacts for other types of communication between the guide devices 1-1a-1-1c and the CPU 2-7, including contacts for testing functionality by running test data as if the GPS were receiving actual signals and comparing the responses to a reference, or by test of circuitry integrity, or other diagnostic algorithm designed to test specific components of the hardware, software and firmware onboard the guide unit. The guide devices 1-1a-1-1c internal memory, ROM, firmware and software may also all be reprogrammed with appropriate signals by CPU 2-7. For example, such reprogramming may be necessary in the case of a detected malfunction, where an update of internal memory, ROM, firmware or software may be provided, or when updates are available to improve function, accuracy, or the currency of the information being provided. The operation of each electronic guide device 1-1a-1-1c may thus be selectively, remotely and arbitrarily reprogrammed, or even initially programmed. Communication between the guide device 1-1 and the vending machine 2-1 allows information stored within each guide device 1-1a-1-1c, such as total elapsed time of operation or billing particulars, customer data, operational data, recorded errors, and other information, to be communicated to central server 2-15. As a result, appropriate billing receipts and charges can be computed and delivered, as well as relevant rental data.

Further, specific points of interest or groups of such points with which each of the electronic guide devices 1-1a-1-1c has been programmed, can be remotely reprogrammed through CPU 2-7, either in communication with the central server 2-14, or independently. Thus, if a customer rents a guide device for a specific location and the guide device's programming does not contain the required data or contains outdated data then appropriate files maybe loaded into the guide device 1-1a-1-1c to reprogram it with appropriate data.

Alternatively, the guide devices 1-1 may be programmed with sufficient data to cover all possible points of interest or all necessary points of interest. In this case, the remote reprogramming may define which points to use, which order, or date sensitive information such as weather forecasts, animal movements, available ranger talks, road closure, traffic information or any other information that changes and might interest a customer.

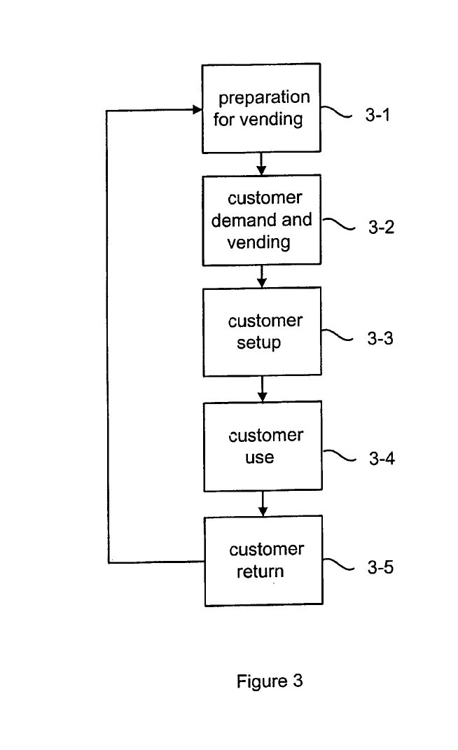

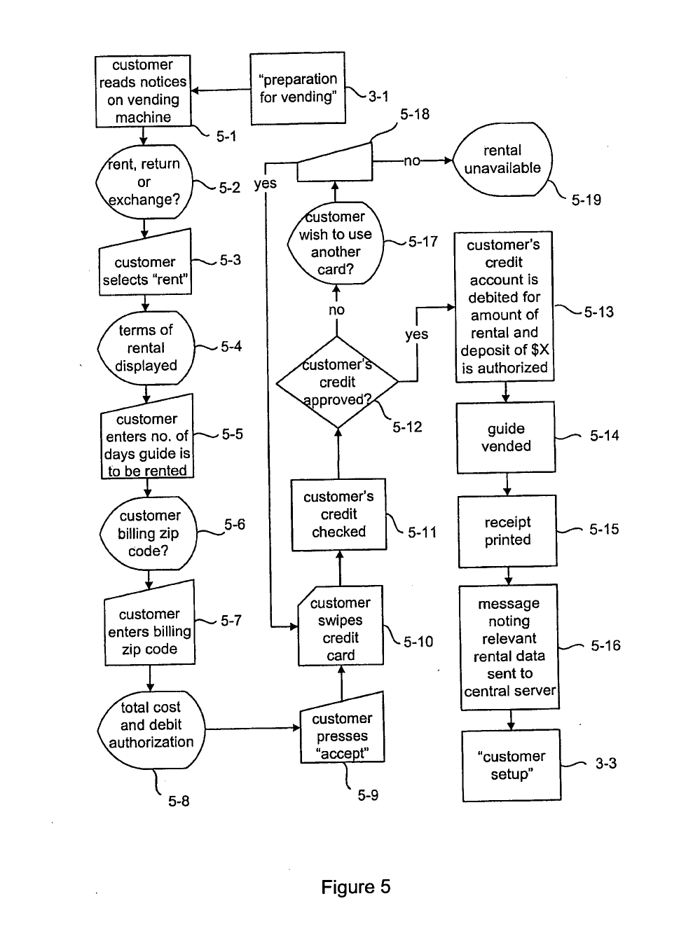

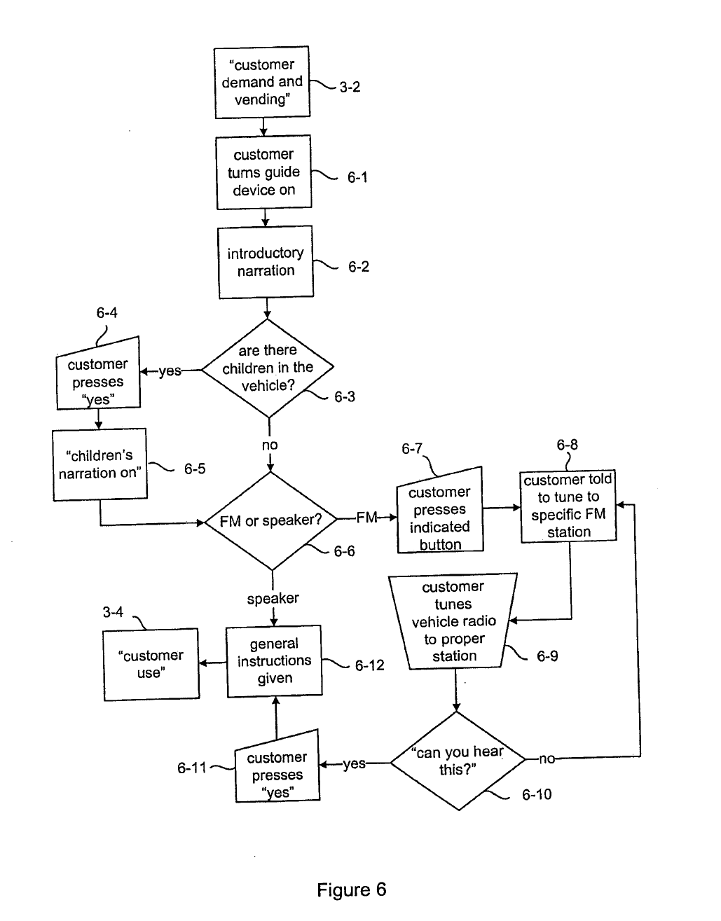

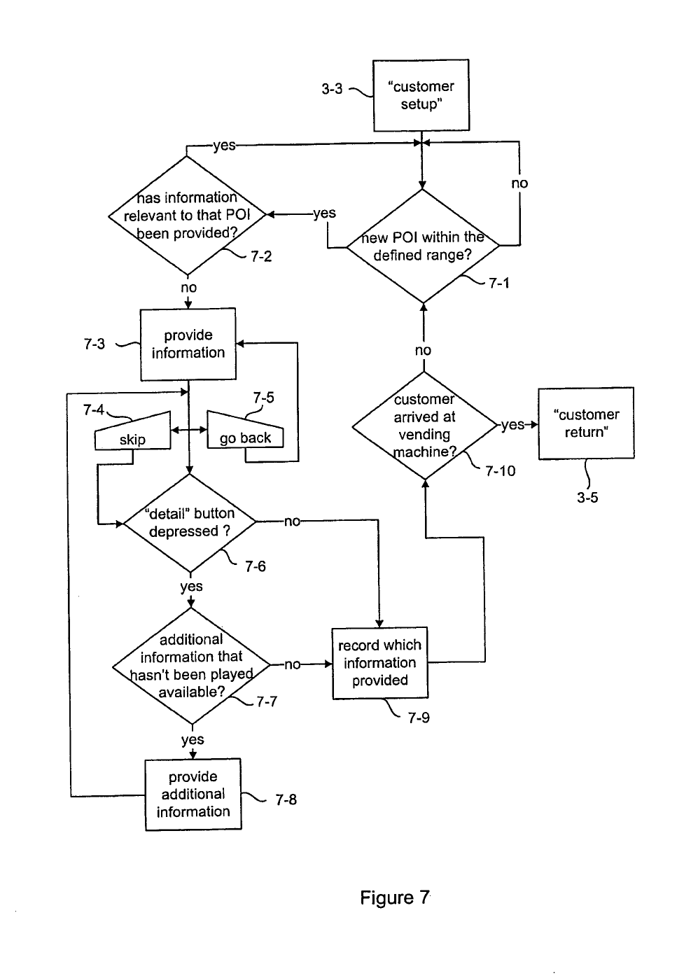

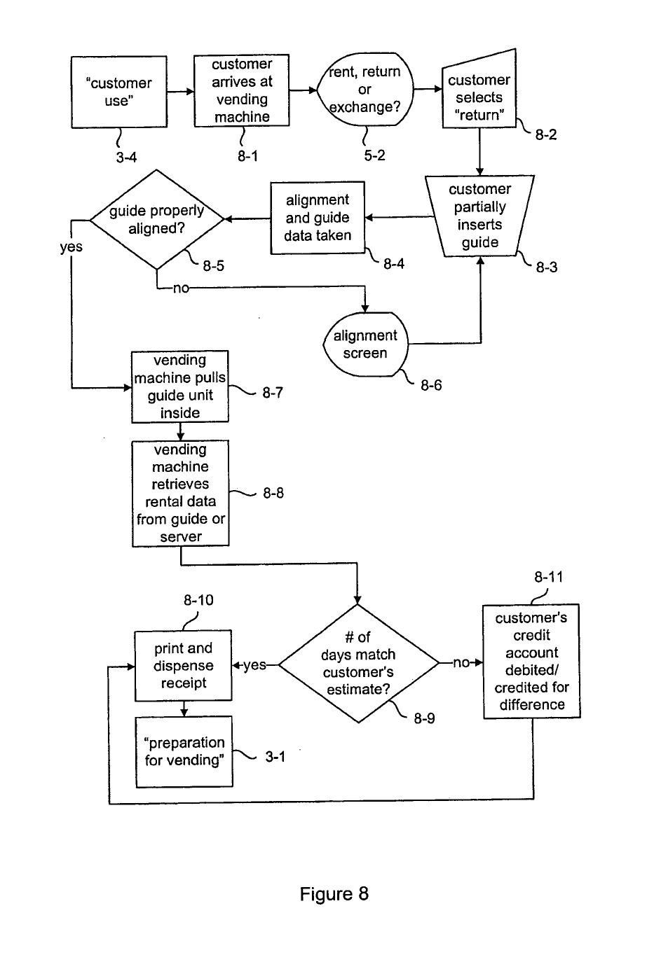

FIG. 3 is a flow chart of the method of the preferred embodiment of the invention, illustrating the full cycle of operation which is implemented when a vending machine 2-1 is put into use with guide devices 1-1a-1-1c. Each block in FIG. 3 represents a more detailed set of steps. Block 3-1 defines “preparation for vending” wherein guide devices 1-1a-1-1c are loaded into vending machine 2-1 and prepared to be distributed to customers according to the method of FIG. 4. Block 3-2 defines “customer demand and vending” wherein a customer interacts with vending machine 2-1 according to the method of FIG. 5. Block 3-3 defines “customer setup” wherein the customer interacts with the guide device according to the method of FIG. 6 in order to prepare the information to be provided by the guide device. Block 3-4 defines “customer use” wherein the guide device 1-1 operates and the customer interacts with it according to the method of FIG. 7. Block 3-5 is “customer return” wherein the customer has finished using the guide device and interacts with the vending machine 2-1 to return the guide device according to the method of FIG. 8.

FIG. 4 is a flow chart of the method of the preferred embodiment in which “preparation for vending” steps are taken to load guide devices 1-1a-1-1c into vending machine 2-1 either by the vendor or during a return of a guide device 1-1 by a customer (Block 4-1; see FIG. 8) and to prepare the guide device to be distributed or redistributed to further customers. More particularly, after the guide devices 1-1a-1-1c are loaded, they are tested (Block 4-2) for functionality by CPU 2-7 through busses 2-11 and 2-14 and the connector 2-2 using any of the diagnostic methods contemplated above, or other analysis methodologies known in the art of electronic device testing and repair. In Block 4-3 the results of the test in 4-2 are used to either send a message to the central server 2-14 that the guide device is not functioning (Block 4-4) or begin the battery charging cycle described in Blocks 4-5 and 4-6. If a unit is not functioning properly, whomever is displaying the central server 2-14 can then dispatch a repair or replacement (not shown) or the vending machine 2-1 can attempt repair itself (not shown) by testing functionality as discussed above, by running test data, by test of circuit integrity, or by running diagnostic algorithms such that proper repair may be achieved by reprogramming of internal memory, ROM, firmware and/or software with appropriate signals by CPU 2-7.

Once the guide device 1-1 is fully charged, CPU 2-7 may have either already received updates to the software, ROM or firmware for the guide devices, or can check for new updates in the central server 2-15 through modem 2-8 (Block 4-7). If updates are available, the guide device 1-1 is updated (Block 4-8). After update, or if there is no update available, the guide is put on a “vendable” list maintained in the CPU 2-7 (Block 4-9) and possibly that list is communicated to the central server 2-15 (not shown). The guide devices 1-1a-1-1c that are on the “vendable” list are then ready to be dispensed to a customer in FIG. 5 “customer demand and vending” (Block 3-2 of FIG. 3). At any time, or at pre-determined intervals, the vending machine 2-1 may return to Block 4-2 to re-test and charge the guide devices 1-1a-1-1c stored therein so as to assure proper updating and charging.

FIG. 5 is a flow chart of the method of the preferred embodiment wherein a customer interacts with vending machine 2-1 by approaching it and reading general instructions for use posted on permanent or semi-permanent graphic displays (not shown) (Block 5-1), and after reading text indicating, for example, three choices on touchscreen display 2-5: “rent”, “return” or “exchange” (Block 5-2). The customer selects “rent” by touching the relevant area on the touchscreen display 2-5 (Block 5-3), and the terms of rental are displayed on the touchscreen display 2-5 (Block 5-4) including a request for the customer's estimate of the number of days the guide device will be rented for. In Block 5-5 the customer enters the number of days he or she expects to be using the guide device 1-1. The touchscreen display 2-5 then displays a request that the customer enter the billing address zip code for the credit card she or he intends to use for the rental transaction (Block 5-6). In Block 5-7 the customer enters their billing zip code, and in Block 5-8 touchscreen display 2-5 then displays the total cost and deposit authorization information, and if the customer desires to continue, she presses “accept” on the touchscreen display 2-5 (Block 5-9) and swipes her credit card (Block 5-10).

The customer's credit is then checked (Block 5-11) and if it is approved (Block 5-12) the customer's credit account is debited for the amount of rental and a deposit of the correct amount is authorized (Block 5-13). If the customer's credit is not approved for whatever reason, the touchscreen display 2-5 asks the customer if they would like to use a different card (Block 5-17). The customer presses “yes” or “no” (Block 5-18) and either swipes another credit card (Block 5-10) or the display 2-5 tells them that rental is unavailable (Block 5-19), terminating the transaction. If the customer's credit was approved, one of the guide devices 1-1a-1-1c that is fully charged, pre-tested, and held in inventory is dispensed in Block 5-14 to the customer by electromechanical dispenser/receiver 2-3, and then, or simultaneously, a receipt is printed for the customer (Block 5-15) by printer 2-9. A message noting all of the relevant rental data, date, time, guide device serial number, customer's identity and credit, and any other pertinent information is sent to the central server 2-14 through modem 2-8 for any further processing or tracking required (Block 5-16). It is then time for the customer to turn the guide device 2-2 on and set it up (Block 3-3) of FIG. 3.

FIG. 6. is a flow chart of the method of the preferred embodiment wherein a customer, having been vended one of guide devices 1-1a-1-1c, gets back into their vehicle, places the guide device 1-1 someplace where it can receive GPS signals, then turns the guide device on (Block 6-1). The guide device 1-1 then produces an introductory narration that welcomes the customer to the system and to the location they are about to drive through its onboard speaker (Block 6-2). It then asks whether there are children in the vehicle (Block 6-3), the customer presses the button indicated for “yes” if there are (Block 6-4), and the unit indicates that the child-oriented narration is enabled (Block 6-5). This step may be repeated as many times as useful to enable the provision of any other relevant type of detail, different language, different focus, etc., desired by the customer and available on the system.

Whether the customer pressed “yes” or not, the guide device then asks whether the customer would like to use their FM radio to listen to the narration, or to continue using the onboard speaker (Block 6-6). The FM radio will generally be the preferred mode of listening, as the car radio will have better sound, reach any passengers in the back of the vehicle, and be easier to adjust. However, the onboard speaker is also available in case the customer would also like to listen to music simultaneously, doesn't have a radio in their vehicle, or other reasons. The customer will be instructed to press a button indicated to choose their radio (Block 6-7) or to do nothing and continue using the onboard speaker. If they choose to use their radio, they will then be told to tune their radio to a specific FM station (Block 6-8). Once they have been given time to do so (Block 6-9), the guide device 1-1 will broadcast on the proper FM frequency and ask if it can be heard (Block 6-10) and will instruct the user to press a particular button if they can. If they can hear it, the customer presses the indicated button (Block 6-11) and is given general instructions just as if they had not selected the radio broadcast option (Block 6-12). The customers then proceed to drive into the area of interest and use the guide device 1-1 (Block 3-4).

FIG. 7. is a flow chart of the method of the preferred embodiment wherein after the customer has set up guide device 1-1 that he or she was vended, and is driving, walking or using almost any method of conveyance, through the area of interest, whether a National Park like Yellowstone, or a city with rich history like San Francisco or Venice, Italy. In a city like Venice, where water is a major source of transportation, a likely method of conveyance would include boats, or in a walking city like New Orleans, all the customer might be using is their shoes. The invention is intended to include all such types of experiences of areas of interest, including all types, for example, the National Mall or the Grand Canyon, and all modes of transport, even helicopters, bicycles, motorcycles, snowmobiles or donkeys.

Once the customer enters the area of interest, the guide device 1-1 is constantly updating its known position through the well known typical operation of GPS hardware receiving and processing the GPS signals from the US military's satellites. With each new update, the guide device 1-1 looks to its internal memory to determine whether there is a new point of interest (“POI”, i.e., a view, an animal habitat, an historical object or building, Old Faithful Geyser, any number of things that might interest a visitor to the area) within a predetermined distance or predetermined time interval from the customer's current location (Block 7-1). If no new POI is available, the guide device 1-1 waits for a new position update and asks the question of itself again at that time. If there is a POI within range, the guide device 1-1 preferably looks at its memory for that POI and preferably determines whether that information has already been provided to that particular customer (Block 7-2). If it has, the guide waits for a new position update and asks the first question (Block 7-1) of itself again at that time. If the information has not been provided, the guide device 1-1 provides the information (Block 7-3), and during that operation the customer may choose to press a button to “skip” that information (Block 7-4), a button to repeat the current piece or go back to previous pieces of information (Block 7-5).

At any time, the guide may look at whether a “detail” button has been pressed, for example, during set-up or during the drive (Block 7-6). This button could be any of a number of possible choices, for example, a query whether there is more information available about the POI at hand, but could also include the type of information desired, such as geological, historical, scientific, political, artistic, geographic, or any other type of available information. The customer may have set up which types of information he or she is interested in during the set-up process by answering questions like the question whether there are children in the vehicle (Block 6-3) of FIG. 6. If the “detail” button has been depressed or more detail otherwise selected, the guide then looks at whether there is additional information that has not yet been provided (Block 7-7). If there is additional information, the guide 1-1 provides it according to the process associated with Block 7-3 (Block 7-8). If not, the guide records which information was just played (Block 7-9), a function that may occur at any time during the playing of that information, and unless the customer has arrived at the return location, returns to Block 7-1. If the customer has arrived at a return location or vending machine 2-1 (Block 7-10), the customer then moves to return the guide device 1-1 (Block 3-5) of FIG. 3.

FIG. 8 is a flow chart of the method of the preferred embodiment wherein the guide device rented by a customer is returned to a vending machine 2-1. When the customer arrives at the vending machine 2-1 (Block 8-1), he or she will see the text indicating three choices on touchscreen display 2-5: “rent”, “return” or “exchange” as in Block 5-2 of FIG. 5. The customer selects “return” by touching the relevant area on the touchscreen display 2-5 (Block 8-2), and then partially inserts the guide into electromechanical dispenser/receiver 2-3 which indicated the proper orientation of the guide device by labeling or by the shape of the door (Block 8-3). The vending machine 2-1 senses the orientation through sensor 2-13 or another similar sensor (Block 8-4), and, if the guide device is improperly aligned (Block 8-5), displays a screen describing proper orientation (Block 8-6). If the guide is properly aligned (Block 8-6) the electromechanical dispenser/receiver 2-3 pulls the guide device inside (Block 8-7) and pulls the relevant rental data, such as date and time of rental, identity of renter, etc. from either the memory of the guide device 1-1 or from the central server 2-15 (Block 8-8). The data is compared against the customer's original estimate of the number of days of rental (Block 8-9). If the information matches, printer 2-9 prints a receipt (Block 8-10), but if it does not match the customer's credit account is either debited or credited for the difference (Block 8-11). In either case, upon completion, the process returns to Block 3-1. FIG. 8, with provision for dispensing of a replacement device may also generally show the process of an exchange of a guide device that is not operating properly or has a depleted battery, so that a customer may continue to enjoy the service.

Many modifications and alternations may be made by those having ordinary skill in the art without departing from the spirit and scope of the invention. For example, many of the method steps described in connection with FIGS. 3-8 may be accomplished in a variety of different sequences, for example, depending upon the desires of the customer. Therefore, it must be expressly understood that the illustrated embodiment has been shown only for the purposes for example and should not be read as limiting the invention as defined in the following claims.

What is claimed is:

1. A system of distributing electronic guide devices, the system comprising:
at least two structures that accommodate and transact corresponding electronic guide devices, each structure including a CPU and a communication device; and
wherein the at least two structures communicate with one another via the communication devices.

2. The system of claim 1, wherein at least one of the CPUs communicates with at least one of the guide devices and relays information regarding the guide device to at least one of a group including a CPU of another structure and a server.

3. The system of claim 1, wherein the structure is adapted to test at least one of the guide devices for operability and communicates a status condition of the guide device to at least one of a group including a CPU of another structure and a server.

4. The system of claim 1, further comprising a server that communicates with the CPU of each structure via the corresponding communication device.

5. The system of claim 4, wherein the structures for accommodating and transacting electronic guide devices include:
an enclosure that accommodates a plurality of the guide devices;
a dispensing mechanism for dispensing the guide devices from the enclosure; and
wherein the CPU is responsive to user input to control the dispensing mechanism to dispense at least one of the guide devices from the enclosure.

6. The system of claim 4, wherein the server compiles information related to distributing the guide devices including at least one of: billing information, guide device trouble, vending dates, vending times, customer data, and reservation data.

7. The system of claim 4, wherein the server communicates with the structures to regulate the distribution of the guide devices.

8. The system of claim 1, wherein the structures for accommodating and transacting electronic guide devices includes:
an enclosure that accommodates a plurality of the guide devices;
a dispensing mechanism for dispensing the guide devices from the enclosure; and
wherein the CPU is responsive to user input to control the dispensing mechanism to dispense at least one of the guide devices from the enclosure.

9. The system of claim 8, further comprising a sensor that communicates with at least one of the guide devices to determine if the guide device is vendable.

10. The system of claim 9, wherein the guide device is battery powered and the sensor detects whether the guide device has a threshold charge.

11. The system of claim 1, wherein the structure is one of a vending machine, an apparatus built into an existing structure and a kiosk.

12. The system of claim 1, wherein the communication device is a modem.

13. A method for automatically providing guide services comprising the steps of:
storing a plurality of electronic guide devices in at least two structures each having a user interface;
communicating with a customer, via the user interface, so as to select at least one guide device; and
dispensing the guide device based on the communicating step.

14. The method of claim 13, further comprising receiving and processing the guide device once the guide device is returned by the customer.

15. The method of claim 14, wherein the receiving and processing step includes providing a dispensing/receiving mechanism.

16. The method of claim 14, further comprising preparing the guide device for re-vending.

17. The method of claim 16, wherein the preparing step includes charging a battery of the guide device.

18. The method of claim 13, further comprising regularly determining a location of the guide device.

19. The method of claim 18, further comprising communicating, via the guide device, information to the customer based on the location.

20. A method of distributing electronic guide devices, the method comprising the steps of:
providing at least two structures that accommodate and transact corresponding electronic guide devices, each structure including a CPU and a communication device; and
communicating guide device information between the two structures.

21. The method of claim 20, wherein the communicating step includes using a server that communicates with the CPUs via the corresponding communication devices.
